(19) United States
(12) Patent Application Publication
(10) Pub. No.: US 2016/0198287 A1
(43) Pub. Date: Jul. 7, 2016

(54) INTERCOM SYSTEM USING AN NFC COMMUNICATION DEVICE

(71) Applicant: ASSA ABLOY AB, Stockholm (SE)

(72) Inventor: Tam Hulusi, Santa Ana, CA (US)

(21) Appl. No.: 14/441,618

(22) PCT Filed: Nov. 27, 2013
(86) PCT No.: PCT/IB2013/003166

§ 371 Date: May 8, 2015

Related U.S. Application Data
(60) Provisional application No. 61/730,875, filed on Nov. 28, 2012.

(51) Int. Cl. H04W 4/00; H04M 11/02; H04B 5/00

(52) U.S. Cl. CPC H04W 4/008; H04B 5/0056; H04M 11/025; H04M 2250/04

(57) ABSTRACT

Methods and systems are provided for enabling NFC communications between a user of an NFC device and a recipient. In particular, an NFC device user may present an NFC device to an NFC tag associated with at least one recipient to initiate an intercom-style communication. The intercom-style communication between the user and the at least one recipient may be facilitated, and even terminated, based on rules stored in memory. Various levels of security may be implemented to prevent attempted communications between unapproved users of NFC devices and recipients. In addition, aspects of the present disclosure anticipate that security rules may be used to grant or deny access to a secured asset.

### FIELD OF THE DISCLOSURE

The present disclosure is generally directed toward communications using NFC devices and corresponding NFC points.

### BACKGROUND

Near Field Communications (“NFC”) is a short-range radio protocol that utilizes principles of magnetic-field induction to enable communication between compatible devices that are in close proximity. In general, NFC operates in the 13.56 MHz frequency band over a distance of several centimeters. NFC standards cover communications protocols and data exchange formats, and are based on existing Radio Frequency Identification (“RFID”) standards including ISO 14443 and ISO 18092, each of which are hereby incorporated herein by reference in their entirety.

The protocol used in NFC can vary depending on the mode of operation employed by the NFC chip and reader. For example, if an active NFC mode is used, both a reader and target (e.g., RFID device) are using their own Radio Frequency (“RF”) field to enable communication between each other. A reader is powered to generate an RF filed of a particular frequency, for instance at 13.56 MHz. The target has its own power supply for digital processing and communications. When the target receives a communication from a reader, the target uses its own power supply to generate another RF field to answer the reader. Communications can occur back and forth between the reader and target in this fashion.

Alternatively, if a passive NFC mode is implemented, the target answers to a reader command in a load modulation scheme. The target is not inherently powered to generate its own RF field. Rather, the target uses energy from the RF field created by the reader to create its RF field and reply to be sent back to the reader. As can be appreciated, NFC targets may be configured as tags, stickers, cards, and/or other objects and these targets are configured to store data in a memory.

Currently, NFC tags may be integrated into posters, bus passes, business cards, sports and entertainment tickets, and the like. Among other things, these NFC tags can be used by an NFC initiator, or equivalent NFC device, to establish connections and communicate information. It is anticipated that the use of NFC can automate many complicated and/or time consuming tasks that an individual may perform during a given day. Although the integration of NFC technology in consumer electronics (e.g., smart-phones, tablets, mobile computing devices, and the like) has rapidly increased, the use of NFC tags to automate and simplify everyday tasks has lagged slowly behind.

### SUMMARY

It is, therefore, one aspect of the present disclosure to provide methods, devices, and systems that allow a user to present an NFC-enabled device within range of a strategically-placed NFC tag and subsequently engage in intercom and/or communications functionality as a result of the presentation. NFC communications are useful in business and personal environments to make it easier to establish communications with a party, or recipient, who is responsible for connecting calls, granting access, denying access, providing information, and/or recording communications and the like. Such communications are not restricted to voice only, but may include digital data communications that exchange data from a portable device and a host and may even be a combination of the two.

As can be appreciated, the NFC communications functionality may be tailored to the needs and/or preferences of a particular individual, business, group, and/or policy. The NFC communications disclosed herein may include, but are in no way limited to, those associated with one or more of an intercom, intercom system, direct-calling system, third-party connected calls, conference calls, paging system, Private Branch Exchange (“PBX”), video chat, multi-media contacts, and the like. For example, a user may be outside of a friend's apartment building and may wish to establish communications with the friend who resides inside the apartment building. In this scenario, the user may have an NFC-enabled communication device, or NFC device, which can be a smart-phone and an associated NFC chip. Moreover, the apartment building may have a secure-access door with an entry panel nearby. This entry panel may include at least one NFC tag. It is anticipated that the entry panel may comprise multiple NFC tags that can be used to represent one or more tenants in the apartment building. Each NFC tag may be associated with a type of tenant identification (e.g., apartment or other number, name, description, avatar, symbol, code, combinations thereof, and/or the like).

Continuing with the example above, the user may present his NFC device to the NFC tag corresponding to his friend's tenant identification (“ID”). Upon presenting the NFC device, the NFC tag provides information to the NFC device that can be used to establish communications. In some cases, the NFC tag may initiate an application that is installed on the NFC device to continue with a specific action. This installed application may use the information contained in the NFC tag to verify the NFC device, permissions, and/or identity of one or more associated user. In the event that an NFC device does not have an appropriate application installed, it is anticipated that the NFC tag may provide information to the NFC device to direct a user to install the appropriate application. Additionally or alternatively, the NFC tag may direct the NFC device to automatically install the appropriate application, with or without approval by the associated user.

In the example above, the friend may receive an NFC communication request from the user outside of the apartment. In some cases, the friend may register one or more users with an NFC communication system. The NFC communication system may reside locally, or remotely (e.g., on the cloud, or accessible via network access) and include rules, permissions, user data, encryption, and/or other information that may be exchanged between one or more NFC device and the system. It is expected that an approved NFC communication system, or administrative user, (e.g., the friend in the present example) may alter and/or update the information stored in the memory associated with the NFC communication system. In some embodiments, registered users/devices who use the NFC communications functionality may be presented to a contacted recipient with an appropriate identification. In the example above, if the friend registered the user who is outside the apartment building, an identification of the user may be presented to the friend when the communication request is made via the NFC communication.

Additionally or alternatively, a user who is not registered with an NFC communication system may still be able to initiate an NFC communication with a recipient. In this case, the communication request may indicate that the user is unknown. For example, an NFC communication request may be displayed on a recipient's device and indicate “Caller Unknown,” which may allow the recipient to decide whether or not to respond to the NFC communication request. Additionally or alternatively, unknown/unregistered users may be denied the ability of placing NFC communication requests to one or more recipients. This denial of placing an NFC communication request may be modified according to security rules, policies, and/or preferences. In one embodiment, unknown/unregistered users may only be allowed to place NFC communication requests during specific time periods. For instance, an unknown/unregistered user may be limited to making NFC communication requests during regular business hours. On the other hand, registered/known users may be permitted to make NFC communications during an expanded time period. As can be expected, the time periods may be applied, adjusted, and/or customized, based on preferences, policies, and/or settings associated with the NFC communication system for both registered and unregistered users.

In some embodiments, the NFC device may utilize a communication application installed on the NFC device to provide the authentication necessary for NFC communication. In the example above, a recipient may send NFC authorization to one or more NFC devices across a network. The authorization may be stored in the NFC device. Accordingly, when the NFC device with locally stored authorization is presented to an appropriate NFC tag, the contact between the NFC device user and the recipient may be made based in part on the security keys previously provided by the recipient.

As can be appreciated, the number of NFC tags and/or security employed at an entry panel, secure-access point, gate, entrance, and/or communication point, may vary depending on anticipated security level, policy, preferences, and/or the like. However, it should be noted that security and other policies may be implemented for cases whether one or more NFC tags are used. For example, a single NFC tag may be used to provide an NFC device with a list of registered communication recipients. These registered communication recipients may be represented by a code, number, avatar, name, description, combinations thereof, and/or a similar ID. Security policies may determine whether all NFC devices, or only specified NFC devices, are allowed to view a list of registered communication recipients. Additionally or alternatively, a customized list of registered communication recipients may be provided to specific or general NFC devices based on similar security policies. In this case, a security policy may be used to provide only specific NFC devices access to one or more of the registered communication recipients. As another example, a specific NFC device user may only know four people in a building, and as such, may only be allowed to view a list of those four people. In this instance, the specific NFC device user may have been registered, or given list view access, by all four of the people. Examples of the NFC device/associated user registration and/or permission grant are provided in this disclosure. In one case, a specific NFC device may be allowed to view all registered communication recipients. As can be expected, various combinations of security policies, levels, and even approaches may be used to best suit the needs of one or more individuals/groups.

It is an aspect of the present disclosure that the NFC communications may be employed by a user to initiate intercom-style communications with another party. For example, a user may present an NFC device to an appropriate NFC tag to connect to an operator, receptionist, assistant, and/or other third party. In some embodiments, the presentation of the NFC device to the NFC tag may cause an application to automatically contact an intended party. Among other things, because NFC does not require a slow and manual connection, or pairing, process to allow for the exchange of information, the NFC intercom-style communication can be as quick as using a traditional intercom system. However, the NFC intercom-style communication disclosed herein provides for limitless expandability, accessibility, integration, and updatability based in part on the ubiquitous nature of NFC devices and the availability of inexpensive, but secure, NFC tags.

The NFC tag may include mechanisms to insure that it is not removed or relocated. For example, the tag may contain mechanisms that render it non-functional by destroying the integrity of the electrical circuitry (e.g., disabling the antenna when the tag is removed from the surface it is affixed to). This may be facilitated by the use of printed electronics which could be utilized in the NFC tag in conjunction with the adhesives used to affix such tag. Another mechanism for insuring tag integrity, and that it has not been relocated, may include storing geo-location data in the NFC tag when it is provisioned and affixed and verifying such data with the geo-location of the device that reads the NFC tag.

There are other applications in which an NFC tag can be used as a convenient way of initiating a voice conversation with a third party. One such case may involve the use of NFC tags as warranty tags. When a warranty issue arises, a consumer could merely locate the warranty tag affixed to the applicable device, read the NFC tag with a mobile phone and a call to the correct number may be initiated. There may even be multiple phone numbers inside the NFC tag along with an explanation and/or description of each number and these could be presented on the display of the phone so that the user may make an appropriate desired choice. Furthermore, when the call is initiated, non-voice data could also be transmitted such as serial number, place and date of sale, name of retailer, etc. If this data were stored in a secure, tamper-resistant manner, it would make it difficult to forge this data, transmitting this additional data makes it possible for the third-party to get this information even if the printing on the warranty tag is no longer readable. As can be expected, this procedure speeds up the time and reduces error associated with such contacts. For applications where sending digital data is problematic, the phone can utilize a text to voice mechanism so that the third-party can retrieve this additional data by voice. In some embodiments, by using the display and keypad of a mobile phone, the third party can ask for specific data by asking the initiator to choose an item from a list that is displayed or even tell him what to enter on the keypad and the application may retrieve the requested data and speak it. As an additional security feature, the data on the NFC tag could be encrypted using a code only known to the third party and tells the initiator to enter it on the keypad. Additionally or alternatively, the digital data may be sent to the mobile phone directly so the user does not have to enter it. In one embodiment, having the third party send device to the mobile phone would allow such data to be written to the NFC tag.

Similarly, another application that would benefit from having one or more phone numbers securely stored on an NFC tag is for service records. In this case, it makes it very easy, for example, to report that there is a maintenance issue and transmit by computer generated voice and/or digital data the contents of the NFC service tag to facilitate resolving the issue.

There are many more applications in which it is advantageous to store phone numbers in an NFC tag and have the phone automatically dial the appropriate phone number to initiate communications of voice, data, or combinations thereof.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Also, while the disclosure is described in terms of exemplary embodiments, it should be appreciated that individual aspects of the disclosure can be separately claimed. The present disclosure will be further understood from the drawings and the following detailed description. Although this description sets forth specific details, it is understood that certain embodiments of the disclosure may be practiced without these specific details. It is also understood that in some instances, well-known circuits, components and techniques have not been shown in detail in order to avoid obscuring the understanding of the invention

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The present disclosure is described in conjunction with the appended figures:

FIG. 1 is a block diagram of an NFC communication system in accordance with embodiments of the present disclosure;

FIG. 2 is a block diagram an embodiment of the hardware of the NFC device;

FIG. 3 shows a secure-access point equipped with components of an NFC communication system in accordance with embodiments of the present disclosure;

FIG. 4A shows a first communication panel for use with an NFC communication system in accordance with embodiments of the present disclosure;

FIG. 4B shows a second communication panel for use with an NFC communication system in accordance with embodiments of the present disclosure;

FIG. 5A shows an NFC device with a communication application in a first state in accordance with embodiments of the present disclosure;

FIG. 5B shows an NFC device with a communication application in a second state in accordance with embodiments of the present disclosure;

FIG. 6 is a flow diagram depicting a first NFC communication method in accordance with embodiments of the present disclosure;

FIG. 7 is a flow diagram depicting a second NFC communication method in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

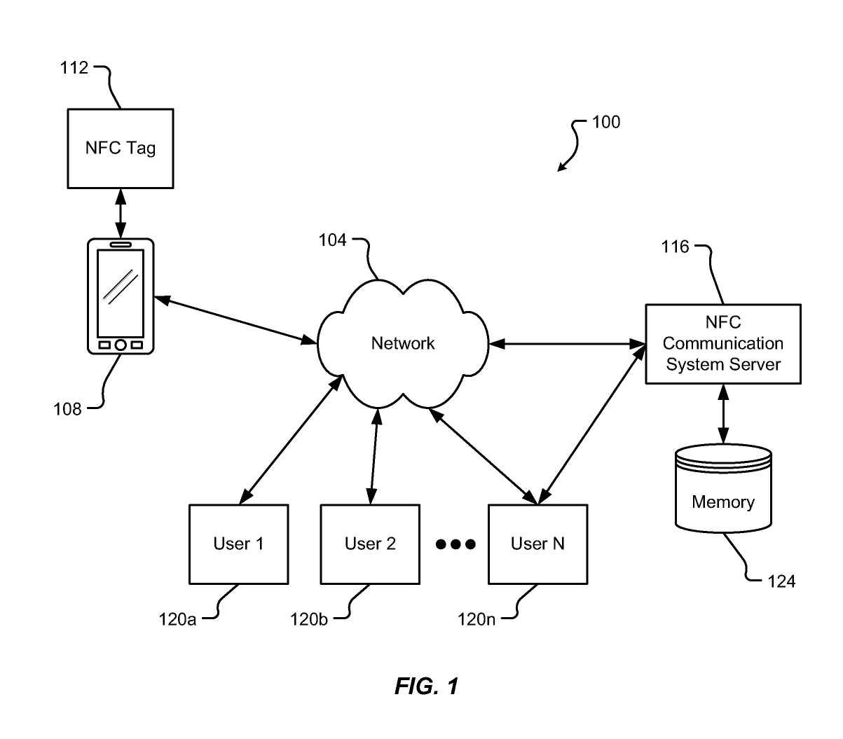

FIG. 1 shows a block diagram of an NFC communication system 100 in accordance with embodiments of the present disclosure. The NFC communication system 100 generally comprises a communication network 104, an NFC device 108, one or more NFC tags 112, an NFC communication system server 116 with associated memory 124. One or more administrative users 120a, 120b, 120n may have access to the NFC communication system server 116 and memory 124 via the communication network 104 and/or via direct connection.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may comprise a number of different communication media such as coaxial cable, copper cable/wire, fiber-optic cable, antennas for transmitting/receiving wireless messages, and combinations thereof.

The NFC device 108 may comprise any type of known communication equipment or collection of communication equipment operatively associated with an NFC chip and antenna, or NFC transceiver. In some cases, the NFC device 108 may comprise a secure element. The secure element may be associated with the NFC device 108 and may be configured to securely store credentials, applications, and/or provide for the secure execution of associated applications. In some cases the secure element may reside in a smart card chip, a subscriber identity module (“SIM”) card, secure application module (“SAM”) card, a secure digital (“SD”) card, or other memory configured in a secure environment. Examples of a suitable NFC device 108 may include, but are not limited to, a personal computer, laptop, Personal Digital Assistant (PDA), cellular phone, smart phone, tablet, mobile computing device, handheld radio, or combinations thereof. In general each NFC device 108 may be adapted to support video, audio, text, and/or data communications with other NFC devices 108 as well as one or more communication device, and/or servers 116. The type of medium used by the NFC device 108 to communicate with other communication devices or servers 116 may depend upon the communication applications available on the NFC device 108. The NFC device 108 may correspond to a communication device associated with a user. It is anticipated that the NFC device 108 may comprise at least one secure memory, or memory that is capable of being at least partially secured. In one embodiment, the at least one secure memory may be used to store security keys, codes, identities, and/or other data that may be used by the NFC device 108 to communicate with an NFC tag 112, NFC communication system server 116, a recipient, combinations thereof, and/or other devices.

In some embodiments, an NFC tag 112 may generally comprise components such as an integrated circuit operatively attached to an antenna and a storage memory. One or more of these components may comprise an NFC chip. The storage memory of an NFC tag 112 may include tag information, contact information, location information, instructions, and/or the like. The components of an NFC tag 112 may be attached to, or within, a substrate for attachment to one or more surfaces. In some cases these substrates may include an adhesive layer to form an NFC tag 112 that is configured to adhere, or stick, to a surface. Other examples of NFC tags 112 may include the surrounding the NFC tag 112 components in a laminate of protective material. As can be expected, the NFC tag 112 may be affixed to, or within, single and/or laminate surfaces of paper, plastic, or combinations thereof. Typical NFC tags 112 may not include a power source, and as such may be called “passive” targets. Passive tags, or targets, may use power that is provided by a nearby powered NFC device 108 when it is placed within a predetermined range of the NFC tag 112.

In some embodiments, NFC tags 112 may include security devices to prevent tampering and/or removal. These security devices may include passive security features built into the NFC tag 112 such as designed tear lines and/or void warnings that can either ruin/destroy the NFC tag 112 or show a warning that the NFC tag 112 has been tampered with. Additionally or alternatively, the NFC tag 112 may employ active security feature such as alarmed tag attachment, reinforced attachment substrate, combinations thereof, and/or the like. NFC tags 112 may be encrypted to prevent the manipulation of data on the tag. As an increased security measure, one embodiment of the present disclosure may utilize an NFC tag 112, and/or NFC device 108, that includes a physical unclonable function (“PUF”) that can facilitate secure challenge-response authentications. In some embodiments, the information stored in a memory associated with an NFC tag 112 may be at least partially obscured and/or encrypted. The obscuring and/or encryption of information stored in memory may prevent unauthorized access to the information. In one embodiment, authorization may be granted by transmitting, by an NFC device 108, a secure code, key, password, and/or PUF.

Although, embodiments of the present disclosure at least anticipate reading passive NFC tags 112 via an NFC device 108, aspects disclosed herein may equally apply to NFC devices 108 reading active NFC devices in lieu of passive NFC tags. In some cases, an active NFC device may be configured to appear as an NFC tag 112 in general size and/or shape. For example, a building may utilize an embedded active NFC device as an NFC tag 112 for the purposes of the present disclosure. In other words, the NFC communication system 100 disclosed herein may be utilized in an active-passive, active-active, and/or passive-active configuration as arranged by design. Accordingly, the present disclosure may use the term NFC tag 112 to include passive tags and/or active devices that are configured to be read by an NFC device 108.

An NFC communication system server 116, in accordance with embodiments of the present invention, may comprise a communication server or other dedicated processor that functions to provide services to devices (e.g., NFC devices 108, communication devices, etc.). A user of the NFC device 108 may employ various applications on the server 116 and/or on the NFC device 108 to at least provide NFC communication functionality as disclosed herein.

The NFC communication system server 116 may be associated with a server memory 124. In some embodiments, the server memory 124 may be configured to store information relating to NFC communications, NFC devices 108, NFC tags 112, permissions, encryption, user data, identification, location information, communication links, and the like. An administrative user 120a, 120b, 120n, may have access to the NFC communication system server 116 and associated server memory 124 to manipulate data stored thereon. Among other things, the administrative user 120a, 120b, 120n, may register a user associated with an NFC device 108 via the server 116 and its associated memory 124 via a communication application running on the NFC communication system server 116. It is anticipated that an NFC device 108 may read an NFC tag 112 and upon doing so, communicate across a communication network 104 with the NFC communication system server 116 and associated memory 124 to facilitate NFC communications between a user associated with the NFC device 108 and a recipient. In some cases, the recipient may be associated with the NFC tag 112.

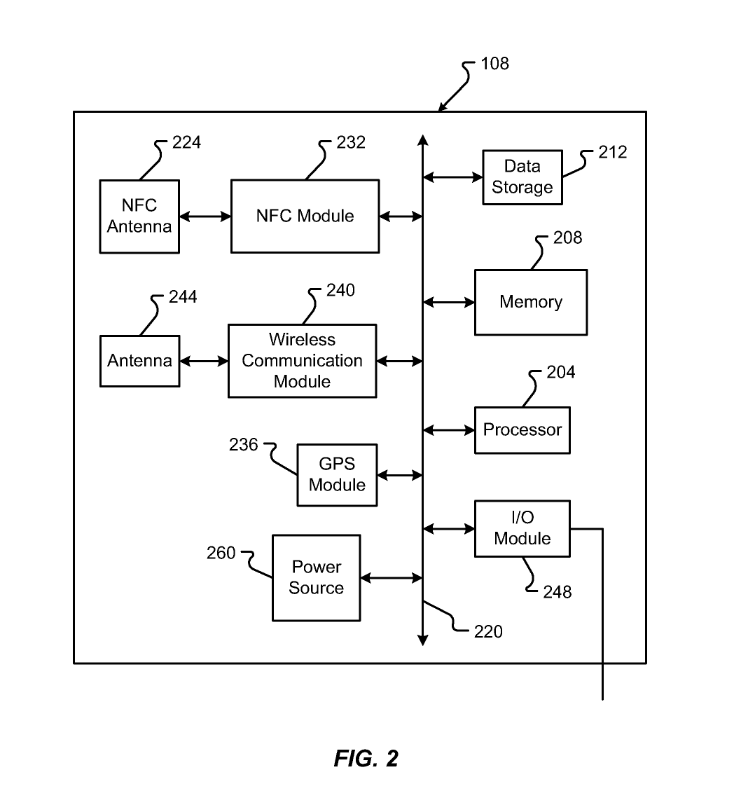

FIG. 2 illustrates components of an NFC device 108 in accordance with embodiments of the present disclosure. In general, the NFC device 108 may comprise one or more of a processor 204, memory 208, data storage 212, NFC module 232, NFC antenna 224, and a power source 260. Some embodiments of the NFC device 108 may additionally include a Global Positioning System (“GPS”), or equivalent geographical location module, 236, wireless communication module 240, antenna 244, Input/Output (“I/O”) module, and more. In some cases the NFC device 108 may comprise various NFC components that form an NFC transceiver (e.g., NFC antenna 224, NFC module 232, power source 260, and/or a processor 204 etc.).

The processor 204 may comprise a general purpose programmable processor or controller for executing application programming or instructions. In accordance with at least some embodiments, the processor 204 may include multiple processor cores, and/or implement multiple virtual processors. In accordance with still other embodiments, the processor 204 may include multiple physical processors. As a particular example, the processor 204 may comprise a specially configured application specific integrated circuit (ASIC) or other integrated circuit, a digital signal processor, a controller, a hardwired electronic or logic circuit, a programmable logic device or gate array, a special purpose computer, or the like. The processor 204 generally functions to run programming code or instructions implementing various functions of the NFC device 108.

A NFC device 108 may also include memory 208 for use in connection with the execution of application programming or instructions by the processor 204, and for the temporary or long term storage of program instructions and/or data. As examples, the memory 208 may comprise RAM, DRAM, SDRAM, or other solid state memory. Alternatively or in addition, data storage 212 may be provided. Like the memory 208, the data storage 212 may comprise a solid state memory device or devices. Alternatively or in addition, the data storage 212 may comprise a hard disk drive or other random access memory.

The NFC device 108 includes at least one NFC chip, or module, 232 and at least one associated NFC antenna 224. As can be appreciated, the NFC chip/module 232 may comprise one or more of the NFC antenna 224 and at least one secure element. In some embodiments, the NFC module 232 may be configured to produce a magnetic field via the NFC antenna 224. This magnetic field produced by the NFC module 232 and antenna 224 may be configured to induce corresponding electrical activity in an NFC tag 112. In turn, a passive NFC tag 112 may generate its own a radio field, using the power borrowed from the NFC device 108 that may be supplied via the magnetic field. It is an aspect of the present disclosure that the NFC module 232 and NFC antenna 224 may detect and even interpret the radio field (e.g., within the NFC range, 13.56 MHz) produced by the NFC tag 112. In some cases, the radio field produced by the NFC tag 112 may initiate one or more applications and/or features used by the NFC device 108.

In addition, the NFC module 232 may include security features that may be employed to encrypt, decrypt, and/or store secure information. In some embodiments, the NFC module 232 may communicate with other components of the NFC device 108 and/or NFC communication system 100 to prepare and exchange data.

In support of communications functions or capabilities, the NFC device 108 can include a wireless communication module 240. As examples, the wireless communication module 240 can comprise a GSM, CDMA, FDMA and/or analog cellular telephony transceiver capable of supporting voice, multimedia and/or data transfers over a cellular network. Alternatively or in addition, the wireless communications module 240 can comprise a Wi-Fi, BLUETOOTH™, WiMax, infrared, or other wireless communications link. The wireless communications module 240 can be associated with a shared or a dedicated antenna 244.

An I/O module 248 and associated ports may be included to support communications over wired networks or links, for example with other communication devices, server devices, and/or peripheral devices. Examples of I/O include an Ethernet port, a Universal Serial Bus (USB) port, Institute of Electrical and Electronics Engineers (IEEE) 1394, or other interface.

The NFC device 108 can also include a satellite positioning system, or geographical location system, module/receiver 236 such as the Global Positioning System (“GPS”) (US), GLONASS (Russia), Galileo positioning system (EU), Compass navigation system (China), and Regional Navigational Satellite System (India). In accordance with embodiments of the present invention, a GPS receiver may further comprise a GPS module 236 that is capable of providing absolute location information to other components of the NFC device 108 and/or NFC communication system 100. In some embodiments, a geographical location of the NFC device 108 may be determined by the device's location-based features, a location signal, and/or combinations thereof. The location-based features, and corresponding module 236, may utilize data from one or more satellite positioning systems (e.g., GPS), WiFi access points, cell towers, and the like.

Communications between various components of the NFC device 108 may be carried by one or more buses 220. Moreover, power can be supplied to the components of the NFC device 108 from a power source and/or power control module 260. The power control module 260 may, for example, include a battery, an AC to DC converter, power control logic, and/or ports for interconnecting the NFC device 108 to an external source of power.

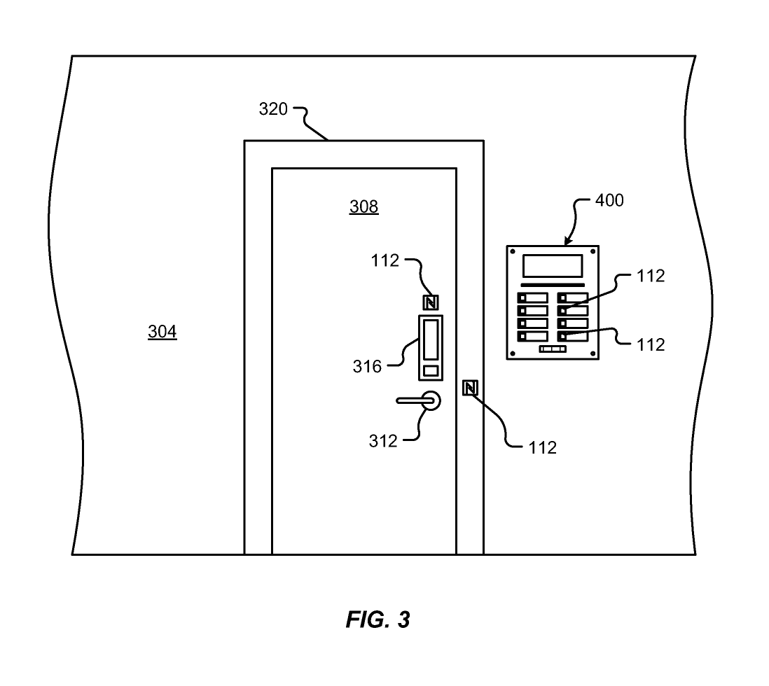

Referring now to FIG. 3, a secure-access point equipped with components of an NFC communication system 100 is shown in accordance with embodiments of the present disclosure. In general, the secure-access point may be represented by a structure, such as a wall, 304 with at least one entrance (e.g., gate, hatch, door, etc.) 308, entrance handle 312, and an entry, or NFC communication, panel 400. The entrance 308 may be at least partially surrounded by a frame 320. As can be expected, the entrance 308 can be locked via a locking system 316, such that access through the structure 304 can be selectively restricted. In some cases, the locking system 316 may be remotely and/or locally controlled to selectively permit or deny access via the entrance 308.

In some embodiments, the secure-access point may represent an entrance 308 to a business or residential building. One or more NFC tags 112 may be positioned on, or adjacent to, the entrance 308 to the building (e.g., on or adjacent to a, wall 304, door 308, frame 320, communication panel 400, and the like). These NFC tags 112 may be configured to facilitate communication between an NFC device 108 and one or more of a recipient, a third party, a server 116, and/or server memory 124, as disclosed herein.

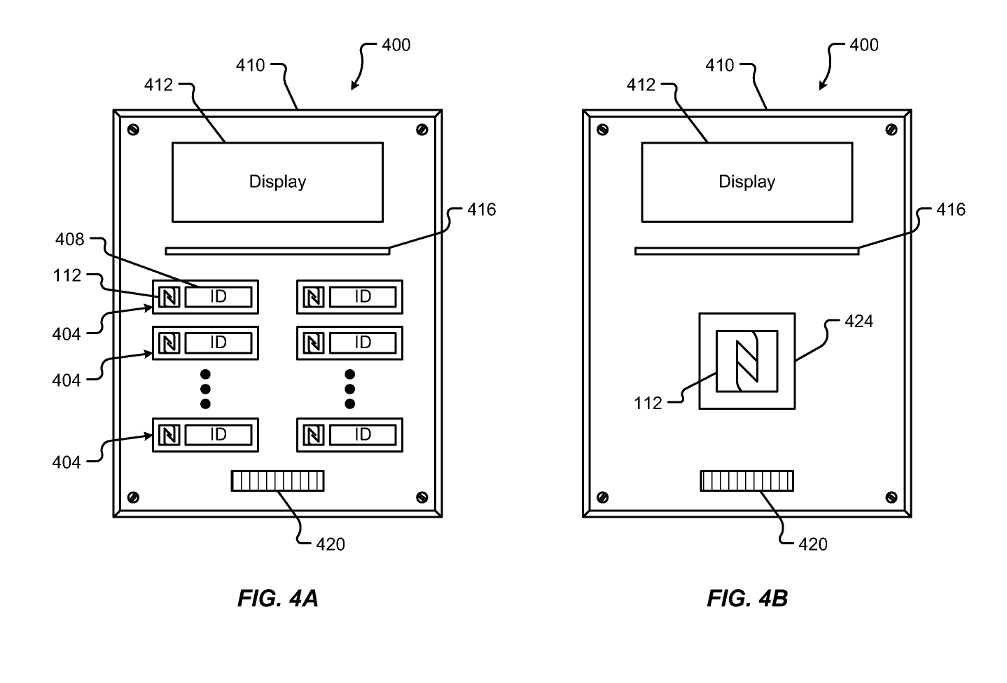

FIGS. 4A and 4B show various embodiments of a communication panel 400 configuration in accordance with aspects of the present disclosure. Depending on the embodiment, the NFC communication system 100 can utilize one or more NFC tags 112 to facilitate communications. In any event, all of the embodiments presented can provide security for the control of access permission. Each communication panel 400 may include one or more of a housing 410, a display 412 (e.g., Liquid Crystal Display (“LCD”), Light Emitting Diode (“LED”), video, text, etc.), an illumination feature 416 (e.g., light, luminescent section, etc.) an audio input/output 420 (e.g., a microphone and/or speaker), and at least one NFC tag 112.

FIG. 4A shows a first communication panel for use with an NFC communication system 100 in accordance with embodiments of the present disclosure. In general, the communication panel 400 depicted includes multiple NFC ID blocks 404. Each NFC ID block 404 may include an NFC tag 112 and a corresponding ID mark 408. The ID mark 408 may be represented by a feature that can be interpreted by an individual and/or a machine to determine at least one individual who may be associated with the NFC tag 112 in the NFC ID block 404. For example, each NFC ID block 404 may represent a different individual, group, or unit number in a building. As such, the ID mark 408 may be one or more of a name, number, character, combination of characters, image, hologram, avatar, barcode, Quick Response (“QR”) code, and the like. In one case, the communication panel 400 may be used outside of a residential building with multiple apartment units. In this instance, each NFC ID block 404 may include an occupant name of each apartment unit in the ID mark 408. Continuing this example, a user may wish to initiate a communication (e.g., an intercom communication) with an individual in one of the multiple apartment units. The user may present an NFC device 108 to the NFC tag 112 next to the name associated with the individual inside the appropriate NFC ID block 404. Presuming that the NFC communication system is configured to accept the contact, the user will be connected with the individual called.

As can be appreciated, various levels of security may be implemented via the communication panel 400. Among other things, the ID mark 408 may be configured to be unrecognizable to strangers. For example, the ID mark 408 may comprise a code, an obscure image, or other mechanism that does not disclose the identity of an associated individual, without knowing how the individual maps to a given ID mark 408. In one embodiment, the obscure image may be a random avatar, where one individual may be represented by a picture of a palm tree, and another individual may be represented by a picture of an automobile, and so on. These representations would be displayed as the ID mark 408 for the respective NFC ID block 404. Visitors could be told by the individual what their avatar was prior to arriving at the apartment. When the visitors arrived, they could present their NFC devices 108 to the NFC tag associated with the appropriate avatar in the ID mark 408 to initiate the communication application on their NFC device 108 (and contact the individual). Although described as applying to an individual, it should be appreciated that the methods disclosed herein may apply in scenarios where more than one individual is represented by a single NFC tag 112, ID mark 408, and NFC ID block 404. This scenario may commonly occur in a residential context with families, roommates, and/or multiple tenants in a general space. In a business context, more than one individual could be represented by business group, location, rank, and the like.

Referring to FIG. 4B, a second communication panel for use with an NFC communication system 100 is shown in accordance with embodiments of the present disclosure. In this embodiment, a communication panel 400 is shown that utilizes a single NFC tag 112 to initiate communication with one or more individuals. The NFC tag 112 may be mounted on, behind, or adjacent to a mounting surface 424. In some embodiments, the mounting surface 424, or the NFC tag 112, itself may be configured to protect the NFC tag from being tampered with or removed from an installation. In one embodiment, the mounting surface 424 may be configured such that the NFC tag can be replaced by an authorized party. In another embodiment, the NFC tag 112 may be manufactured from a tamperproof material. For example, the NFC tag 112 may be manufactured from a reinforced material (e.g., linen, paper, plastic, nylon, polyimide, phenolic, garolite, DuPont™ brand plastics/resins, such as, Kevlar®, Mylar®, Vespel®, Surlyn®, combinations and/or laminations thereof, and the like). As another example, the NFC tag 112 and/or incorporate one or more security features that may indicate whether the NFC tag 112 has been tampered with (e.g., security labels, void labels, tamper strips, etc.).

It is an aspect of the present disclosure that the single NFC tag 112 communication panel 400 shown in FIG. 4B can provide multiple communication approaches depending on the specific implementation. In one embodiment, a user who presents an NFC device 108 to the NFC tag 112 may be connected, via a communication application used by the NFC device 108, with a third party operator, or receptionist. This example allows security to be handled in part by the third party operator. By way of example, a user may wish to contact someone in a restricted area via the NFC communication system 100. This user may present the NFC device 108 to the single NFC tag 112 at the communication panel 400. As a result, the NFC tag 112 may provide the user's NFC device 108 with data that initiates a communication application that contacts the third party operator. Once in communication with the third party operator, the user may request to speak with a specific individual. It is anticipated that the operator may connect the user to the specific individual via the communication application and server 116.

In another embodiment, a user may be given permissions prior to presenting the NFC device 108 to the NFC tag 112 to view and/or contact one or more individuals. Additionally or alternatively, a user may be given permissions that grant access to a secure-point. The user permission may be provided by an administrative user 120a, 120b, 120n, before the NFC device user arrives at a communication panel 400. In one embodiment, the administrative user 120a, 120b, 120n may connect with the NFC communication server 116 and generate or alter an approved visitor/contact or registered user list that is stored in associated server memory 124. The registered user list may include user names, identification, and/or associated NFC device 108 names and/or identifications. Once a registered user presents an NFC device 108 to the NFC tag 112, the NFC tag 112 may direct the NFC device to initiate a communication application and exchange information with the NFC communication system server 116. This may allow the registered user to select from a list of individuals to contact and/or be granted access to a secure-access point remotely. In the latter case, the NFC communication system server 116 may either communicate with a locking system 316 (via the communication network 104) to remotely unlock the appropriate entrance 308, or the NFC communication system server 116 may retrieve and transmit security keys to the NFC device 108 to unlock the appropriate entrance 308.

In yet another embodiment, a communication panel 400 may be equipped with a communication module (e.g., wired or wireless communication module, etc.) that can be initiated upon presenting a passive tag to an active device installed in the communication panel. Additionally or alternatively, the communication panel 400 may be equipped with a communication module that can be initiated upon presenting an active device (e.g., an NFC device 108) to an active device installed at the communication panel 400. In any event, it is anticipated that a user may present an active or passive device to the communication panel 400 to initiate a communication between the communication panel 400 and at least one recipient. The user may communicate to the recipient via the communication panel 400, where voice communication can be exchanged via the audio input/output 420. As can be appreciated, the display 412 may aid in visual communication and/or multimedia communication between the user and the recipient.

For example, a user may possess a passive NFC tag 112 that contains contact information relating to a recipient. In some cases, the NFC tag 112 may be part of a recipient's business card. This user may present the business card (or other substrate) having the passive tag to a communication panel 400 at a corresponding active NFC tag 112 (e.g., with its own power source, etc.) that is associated with the communication panel 400 (e.g., in a passive-active operation). Upon presentation, the communication panel 400 would read the presented passive tag and may determine to initiate an intercom communication with a recipient (associated with the presented passive tag) via the communication panel 400. When the recipient is contacted via the communication panel 400, the user and the recipient may communicate through the various features (e.g., audio input/output 420, display 412, etc.) associated with the communication panel 400.

In another example, a user may similarly initiate the intercom communication with a recipient, as disclosed herein, by presenting an NFC device 108 (or active NFC tag 112) to the communication panel 400 (e.g., in an active-active operation). As can be expected, the communication panel 400 may include one or more active NFC tag 112, passive NFC tag 112, or combinations thereof and still be capable of establishing intercom communications with at least one recipient.

Additionally or alternatively, an administrative user 120a, 120b, 120n, may provide a user of an NFC device 108 with authentication by sending the authentication directly to the user across the communication network 104. In one embodiment, the authentication may be in the form of shared keys that can be exchanged between the NFC device 108 and an NFC tag 112.

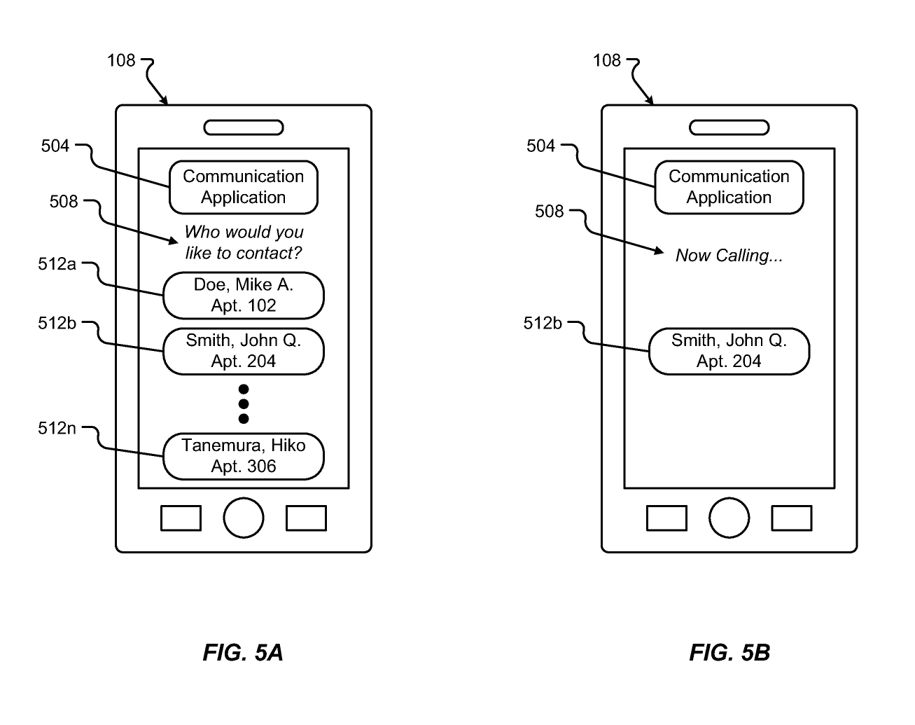

FIG. 5A shows an NFC device 108 with a communication application 504 in a first state in accordance with embodiments of the present disclosure. In some embodiments, the communication application 504 may be configured to initiate upon receiving a signal from an NFC tag 112. In other words, when the NFC device 108 is presented to an NFC tag 112, the magnetic field produced by the NFC device 108 allows the NFC tag 112 to generate a radio field that is detected by the NFC device 108. This radio field may include instructions that are interpreted by the NFC device 108, to open the communication application 504 on the NFC device 108. As a result, the communication application 504 may communicate across the communication network 104 to determine one or more of permissions, user identification, requested contact information, associated NFC tag 112 information, and the like.

In one embodiment, the communication application 504 may retrieve and present a list of available contacts 512a, 512b, 512n. These available contacts 512a, 512b, 512n may be presented based on NFC tag 112 information, permissions of the NFC device user, preferences, policy, security, and/or other methods disclosed herein. Additionally or alternatively, the NFC device 108 may provide an instructional or informational output 508 to an NFC device user. This output may be represented visually, audibly, and/or tactilely (e.g., vibration, etc.). For example, the output may be represented visually to a graphical user interface (“GUI”) of the NFC device 108. In this example, a user of the NFC device 108 may review one or more contacts presented to the GUI. Some embodiments of the NFC device 108 may allow the user to select a particular contact from via the GUI. Upon selecting a particular contact, the NFC device 108 may initiate communication with the selected contact.

FIG. 5B shows an NFC device 108 with a communication application 504 in a second state in accordance with embodiments of the present disclosure. In general, FIG. 5B shows a communication application 504 as an available contact 512b is being called. Accordingly, the informational/instructional output 508 may be altered to indicate that the available contact 512b is being called. It is anticipated that the available contact 512b may be called upon receiving an input provided by the user associated with the NFC device 108. Additionally or alternatively, the available contact 512b may be called automatically. An automatic call may be based on one or more of stored preferences, list size, NFC tag 112 information, and/or data stored in a server memory 124.

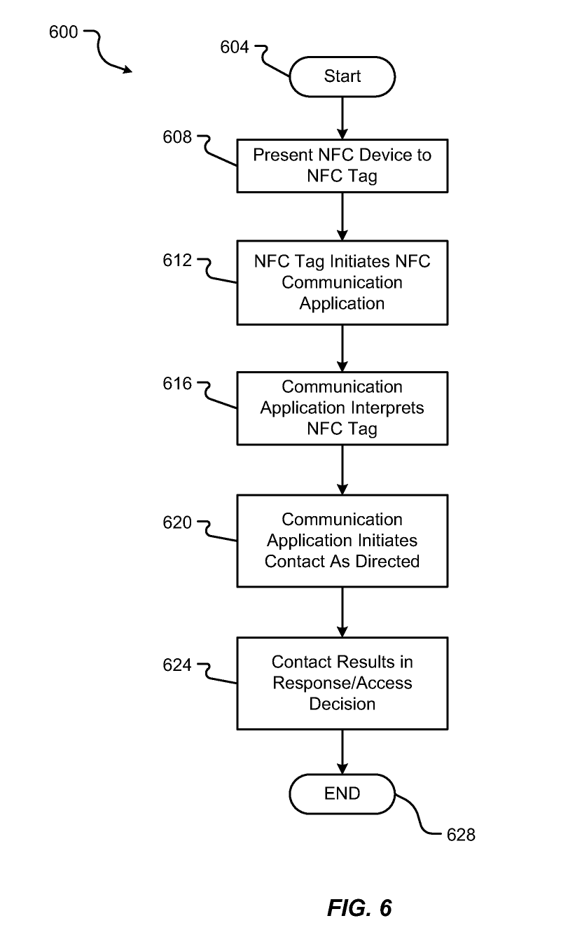

FIG. 6 is a flow diagram depicting a first NFC communication method 600 in accordance with embodiments of the present disclosure. The method 600 begins at step 604 and proceeds when an NFC device 108 is presented to an NFC tag 112 (step 608). Presenting the NFC device 108 may include positioning the NFC device 108 within the operating NFC range of the NFC tag 112. In some cases the operating range may be approximately between 0 and 4 centimeters from a surface of the NFC tag 112. Various configurations of an NFC tag 112 or an NFC device 108 can slightly increase or decrease this typical operating range. Some NFC device users may physically contact, or touch, their NFC device 108 to an NFC tag 112 to facilitate communication between the NFC device 108 and NFC tag 112. Although this contact is not generally necessary to activate the NFC features of an NFC device 108, users may feel more comfortable touching their device to a tag to ensure positioning within the operating range is achieved.

Once the NFC device 108 is presented to an NFC tag 112, the NFC tag 112 may produce a radio field to communicate with the NFC device 108. The communication between the NFC tag 112 and the NFC device 108 may include transferring information, stored in the tag's memory, to the device 108. The method 600 continues when the NFC tag 112, transfers specific information to the NFC device 108, to initiate a communication application 504 of the NFC device 108 (step 612). In some embodiments, the NFC tag 112 may initiate the communication application 504 to receive input from the user of the NFC device 108. Additionally or alternatively, the NFC tag 112 may direct the NFC device 108 to initiate the communication application 504 and automatically run a communication routine in accordance with predetermined rules and/or user preferences. At least one of the communication application 504, computer executable instructions, rules, and user information/preferences may reside on the NFC device 108. In some cases, the communication application 504 executed, at least partially, by the NFC communication system server 116. As such, the communication application 504 may even read, write, and/or use data stored in the associated server memory 124.

At step 616, the communication application 504 associated with the NFC device 108 interprets the data transmitted by the NFC tag 112. In some embodiments, the interpretation may comprise the communication application 504 authenticating a user associated with the NFC device 108. This authentication may involve accessing the NFC communication system server 116 and associated memory 124 across a communication network 104 via the NFC device 108. In other words, the communication application 504 may utilize components (e.g., the wireless communication module 240, antenna 244, memory 208, and/or data storage 212, etc.) associated with the NFC device 108 to access the NFC communication system server 116. The server 116 may use NFC device 108 information (e.g., MAC address, stored data, user data, etc.) to determine an authentication of the NFC device user.

Additionally or alternatively, the authentication process may include, but is not limited to, accessing a GPS module 236, and/or stored data, to verify a current, and/or past, location of the NFC device 108. As can be appreciated, this location verification process may act as a security check to ensure that a user is physically located at a specific position of a corresponding NFC tag 112. In one embodiment, the location information associated with an NFC tag 112 may be compared to the location information associated with an NFC device 108 to determine a qualifying match (e.g., a geo-location within a given threshold, etc). Among other things, the location verification process can thwart possible security bypass techniques that may be employed by a computer, or network, hacker who may attempt to gain access to information stored in the NFC communication system server 116 and/or associated memory 124.

In some cases, the NFC tag 112 interpretation may include providing the NFC device 108 with one or more contacts with whom the user of the NFC device 108 may initiate communication. As disclosed herein, the one or more contacts may be provided based on user information, NFC device 108 information, and/or NFC tag 112 data, to name a few. In one embodiment, the one or more contacts may be presented to the NFC device 108 for user selection. Additionally or alternatively, the one or more contacts may be selected, and even called, automatically.

Depending on the configuration of the NFC communication system 100, the communication application 504 initiates contact as directed (step 620). Although contact with an intended recipient may be based on user selection at the NFC device 108, automatic selection based on stored data and/or preferences, third-party assistance, or combinations thereof, it is anticipated that the communication application 504, and/or the server 116, can similarly terminate an attempted or connected contact. For example, if a user does not have permission to contact any recipient via the communication application 504, the user of an NFC device 108 may be denied the ability to make contact with any recipient. The permissions of users and/or NFC devices 108 may be stored in the server memory 124. These permissions may provide “black-list” (e.g., denied users) and/or “white-list” (approved users) functionality that can be accessed by an NFC device 108 running the communication application 504. Moreover, the permissions may be modified and/or created by one or more administrative users 120a, 120b, 120n.

The method 600 continues by making a connection between the user of the NFC device 108 and the recipient and/or determining access permissions (step 624). Similar to an intercom function, the communication application can connect the user of the NFC device 108 to an intended recipient. Because NFC utilizes a quick connection scheme, the NFC communication system 100 leverages the speed of NFC coupled with the security of wireless communications (e.g., resident on the NFC device 108, communication network 104, NFC communication system server, etc.) to achieve fast and secure intercom-style communications. In some embodiments, the NFC communication system server 116 may grant, or deny, access to a user of an NFC device 108 who has presented the NFC device 108 to a secure-access point. In one embodiment, access via a secure-access point may be granted by a NFC contacted third-party and/or recipient. In at least one scenario, upon concluding the NFC communication, the method 600 ends (step 628).

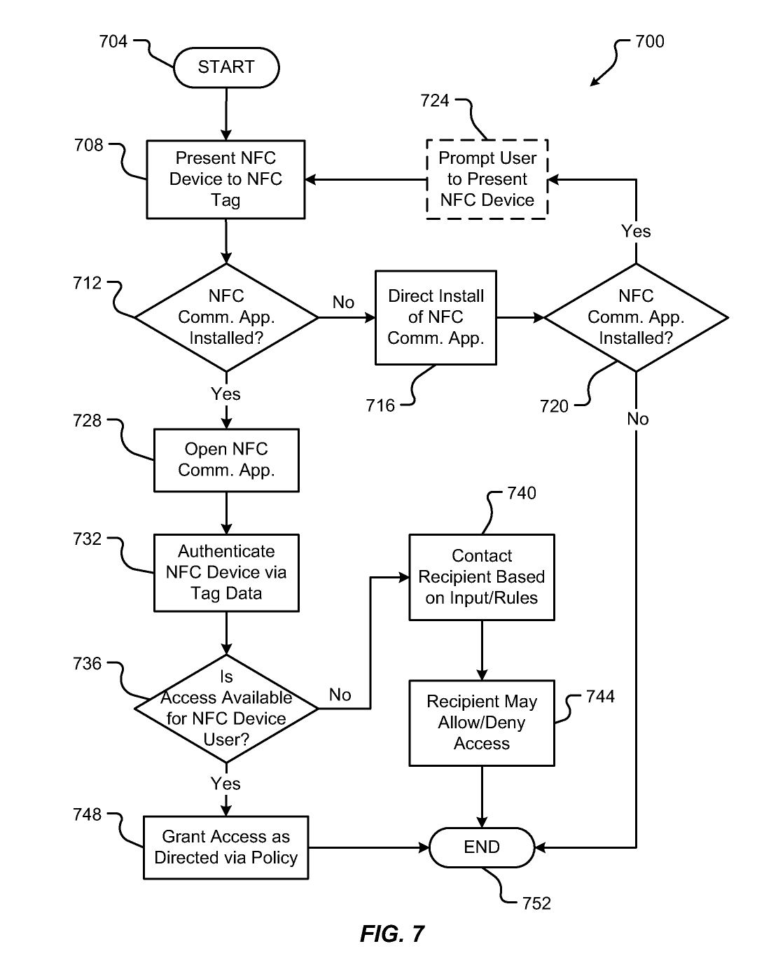

FIG. 7 is a flow diagram depicting a second NFC communication method 700 in accordance with embodiments of the present disclosure. Similar to the first NFC communication method 600 disclosed above, the second NFC communication method 700 begins at step 704 and proceeds when an NFC device 108 is presented to an NFC tag 112 (step 708). As previously disclosed, presenting the NFC device 108 may include positioning the NFC device 108 within the operating NFC range of the NFC tag 112.

The method 700 continues by the NFC device 108 determining whether the communication application 504 is installed on the NFC device 108 (step 712). In other words, once the NFC device 108 is presented to an NFC tag 112, the NFC tag 112 may produce a radio field to communicate with the NFC device 108. The communication between the NFC tag 112 and the NFC device 108 may include information to initiate an application (e.g., communication application 504) on the NFC device 108.

If the communication application 504 is not available (e.g., not installed) on the NFC device 108, the method 700 continues by directing the installation of the communication application 504 (step 716). In one embodiment, the NFC device 108 may be caused to provide an informational output to the NFC device 108. This informational output may inform the user of the NFC device 108 that the NFC tag 112 cannot be read because the communication application 504 is not currently installed on the NFC device 108. In this case, the informational output may further include a prompt and/or link to install the communication application 504. In some embodiments, the NFC device 108 may be directed to automatically install the communication application 504. However, the NFC device 108 may be provided with security controls to prevent the automatic installation of any application without user approval. In these instances, the NFC device 108 may prompt a user for approval prior to installing the communication application 504.

In some embodiments the NFC device 108 may verify whether the communication application 504 is installed on the NFC device 108 (step 720). In the event that a user has declined to install the communication application 504, or if the communication application 504 did not otherwise install, the method 700 ends (step 752). Upon detecting that the communication application 504 has installed on the NFC device 108, the method 700 may proceed by prompting the user to present, or re-present, the NFC device 108 to the NFC tag 112 (step 724). At this point, the method 700 may continue from step 708.

The method 700 continues by opening the communication application 504 on the NFC device 108 (step 728). In some embodiments, opening the communication application 504 may include initiating a communication between the NFC device 108 and the NFC communication system server 116 via the wireless communication module 240 and antenna 244 of the NFC device 108. The initiated communication may be used to verify the NFC device 108 with the server 116, log contact information, determine permissions, establish authentication, enable intercom-style features, and more. In some embodiments, this initiated communication may be invisible to the user. In other words, the communication may be performed in the background of user operations with the NFC device.

In some embodiments, the method 700 continues when the communication application 504 authenticates a user associated with the NFC device 108 (step 732). This authentication may involve accessing the NFC communication system server 116 and associated memory 124 across a communication network 104 via the NFC device 108. In other words, the communication application 504 may utilize components (e.g., the wireless communication module 240, antenna 244, memory 208, and/or data storage 212, etc.) associated with the NFC device 108 to access the NFC communication system server 116. The server 116 may use NFC device 108 information (e.g., MAC address, stored data, user data, etc.) to determine an authentication of the NFC device user.

Additionally or alternatively, the authentication process may include, but is not limited to, accessing a GPS module 236, and/or stored data, to verify a current, and/or past, location of the NFC device 108. As can be appreciated, this location verification process may act as a security check to ensure that a user is physically located at a specific position of a corresponding NFC tag 112. Among other things, the location verification process can thwart possible security bypass techniques that may be employed by a computer, or network, hacker who may attempt to gain access to information stored in the NFC communication system server 116 and/or associated memory 124.

In some embodiments, a user may be provided access to an asset via the communication application 504. For example, the method 700 may proceed by determining if a user associated with the NFC device 108, or the NFC device 108 itself, is permitted access to a particular secured asset (e.g., a secure-access point, gateway, and the like)(step 736). This determination may be achieved by the communication application 504 in communication with the NFC communication system server 116. In general, the NFC communication system server 116 may store authenticated users/devices that may be granted permission to access a secure asset. These users/devices may be stored in memory 124 associated with the server 116. Additionally or alternatively, the permissions may be based upon other authentication factors, preferences, security rules, and/or policies. In some embodiments, the NFC communication system server 116 may either communicate with a locking system 316 (via the communication network 104) to remotely unlock an appropriate entrance 308. In one embodiment, the NFC communication system server 116 may retrieve and transmit security keys to the NFC device 108 so the user can unlock the appropriate entrance 308 using the NFC device 108.

In the event that a user is determined to have access to an asset, the method 700 continues by granting the determined access as directed by policy (step 748). As can be appreciated, policy may apply to one or more of security rules, preferences, administrative settings, user rank, asset location/security, NFC device 108 location, and the like. Additionally or alternatively, the policy may be modified by one or more administrative users 120a, 120b, 120n.

Where user/device access to a secured asset is not available, the method 700 may continue by providing the NFC device 108 with one or more contacts with whom the user of the NFC device 108 may initiate communication (step 740). The one or more contacts may be provided to the NFC device 108 based on user information, NFC device 108 information, and/or NFC tag 112 data, to name a few. In one embodiment, the one or more contacts may be presented to the NFC device 108 for user selection. Additionally or alternatively, the one or more contacts may be selected, and even called, automatically.

As disclosed herein, the communication application 504 initiates contact with a recipient. The initiation may be based on user selection at the NFC device 108, automatic selection based on stored data and/or preferences, third-party assistance, or combinations thereof, it is anticipated that the communication application 504, and/or the server 116, can similarly terminate an attempted or connected contact.

When a contact is made between the user of the NFC device 108 and a recipient (e.g., intended recipient, third-party, automated response unit, voicemail, etc.) the method 700 continues by allowing the recipient to make an access decision for the user (step 744). The access decision may be made to allow the user access at a secure-access point, gateway, or equivalent area. In some embodiments, the recipient may provide the user with an access code, security keys, and/or combination to unlock a locked asset. In other embodiments, the security keys/codes may be transferred to the user's NFC device 108 via the NFC communication system server 116. The transfer of any security keys across a communication network 104 may be encrypted to prevent security risks that may arise from stolen keys/codes. It should be appreciated that the recipient may cause an remote unlocking of a locking system 316 via instructions sent from the recipient to the NFC communication system server 116, which in turn may send an unlocking signal across the communication network 104 to the locking system 316 at a particular secure-access point. Once the recipient has concluded the intercom-style communication with the user and/or made the access decision, the method 700 may end (step 752).

It should be appreciated that while embodiments of the present disclosure have been described in connection with NFC devices and tags, embodiments of the present disclosure are not so limited. In particular, those skilled in the short-range radio communication arts will appreciate that some or all of the concepts described herein may be utilized by other short-range radio communication technologies. For example, it is anticipated that the communication methods, systems, and devices disclosed herein may be configured in a Bluetooth® (2.4-2.5 GHz band), Bluetooth® Low Energy (e.g., Bluetooth® 4.0), Wi-Fi, Wi-Fi Direct, ANT+ and other short-range communication technologies (e.g., capable of operating at distances less than 50 meters range).

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of establishing an intercom communication via a near field communication (“NFC”) device, comprising:
receiving data transmitted by an NFC tag at the NFC device;
initiating a communication application on the NFC device based on the data received from the NFC tag;
interpreting the data received from the NFC tag;
determining a recipient to contact based in part on the interpretation; and
contacting the recipient, via the NFC device, based on the determination.

2. The method of claim 1, wherein interpreting the data received from the NFC tag, further comprises:
retrieving, from a memory associated with the NFC device, encryption information stored for the NFC tag; and
applying the encryption information to decrypt the data transmitted by the NFC tag.

3. The method of claim 2, wherein the encryption information stored for the NFC tag comprises a physical unclonable function (“PUF”).

4. The method of claim 1, wherein interpreting the data received from the NFC tag, further comprises:
transmitting, via the NFC device, information across a communication network to a server; and
receiving, at the NFC device, intercom communication information from the server.

5. The method of claim 4, wherein the intercom communication information received further comprises contact information associated with one or more identified recipients.

6. A near field communication (“NFC”) device, comprising:
an NFC module;
an NFC antenna operatively connected to the NFC module;
a wireless communication module;
a wireless antenna operatively connected to the wireless communication module;
a memory configured to store a communication application, wherein the communication application is configured to interpret data received via NFC, and wherein the communication application is configured to establish an intercom communication to a recipient via the wireless communication module based on the interpretation of the data received; and
a processor operatively connected to the NFC module and the memory, wherein the processor is configured to execute the communication application.

7. The NFC device of claim 6, further comprising:
a secure memory configured to store one or more of security keys, codes, identities, and data.

8. The NFC device of claim 6, further comprising:
a graphical user interface (“GUI”), wherein the GUI is configured to display information relating to one or more available recipients.

9. The NFC device of claims 8, wherein the GUI is configured to receive a user input, the user input selecting at least one of the one or more available recipients, and wherein the selection directs a communication to be established to the selected at least one of the one or more available recipients.

10. The NFC device of claim 6, further comprising:
a geographical location module, wherein the geographical location module is configured to determine a geographical location of the NFC device.

11. The NFC device of claim 10, wherein the geographical location of the NFC device is based on data obtained from one or more of a satellite positioning system, WiFi access point, and cell tower.

12. The NFC device of claim 6, further comprising:
a power source, wherein the power source is configured to provide power via radio frequency (“RF”) to one or more NFC passive targets.

13. A near field communication (“NFC”) tag, comprising:
an antenna; and
a memory operatively connected to the antenna, wherein the memory is configured to store contact information for one or more recipient, and wherein the stored contact information is one of encrypted and at least partially obscured.

14. The NFC tag of claim 13, wherein the NFC tag employs a physical unclonable function (“PUF”) to encrypt the stored contact information.

15. The NFC tag of claim 13, further comprising:
a first substrate having a first side and a second side, wherein one or more components comprising the NFC tag are attached to one or more of the first and second side.

16. The NFC tag of claim 15, further comprising:
an adhesive layer, wherein the adhesive layer is attached to at least one of the first side and the second side of the NFC tag.

17. The NFC tag of claim 15, wherein the substrate is manufactured from a tamperproof material.

18. The NFC tag of claim 15, further comprising:
a second substrate affixed to the first substrate, wherein the one or more components comprising the NFC tag are contained between the first substrate and second substrate.

19. A near field communication (“NFC”) intercom communication system, comprising:
an NFC tag, wherein the NFC comprises a memory configured to store contact information for one or more recipient, and wherein the stored contact information is one of encrypted and at least partially obscured; and
an NFC device, wherein the NFC device comprises an NFC application, the NFC application configured to perform the method, comprising:
receiving data transmitted by an NFC tag at the NFC device;
initiating a communication application on the NFC device based on the data received from the NFC tag;
interpreting the data received from the NFC tag;
determining a recipient to contact based in part on the interpretation; and
contacting the recipient, via the NFC device, based on the determination.

20. The NFC intercom communication system of claim 19, wherein interpreting the data received from the NFC tag by the NFC application, further comprises:
retrieving, from a memory, encryption information stored for the NFC tag; and
applying the encryption information to decrypt the data transmitted by the NFC tag.

21. The NFC intercom communication system of claim 20, further comprising:
a communication network;
an NFC communication server operatively connected to the communication network; and
a server memory associated with the NFC communication server, wherein the server memory comprises the encryption information stored for the NFC tag, and wherein the NFC device retrieves the encryption information from the server memory via communicating with the NFC communication server across the communication network.

22. The NFC intercom communication system of claim 19, further comprising:
an NFC communication panel, wherein the NFC communication panel comprises a plurality of NFC tags, wherein each of the plurality of NFC tags comprises unique contact information for a unique recipient.

23-26. (canceled)
